(19) United States
(12) Patent Application Publication
(10) Pub. No.: US 2004/0193546 A1
(43) Pub. Date: Sep. 30, 2004

(54) Confidential contents management method

(75) Inventors: Takashi Tokutani, Kawasaki (JP); Takahisa Hatakeyama, Kawasaki (JP); Yoshie Yamanaka, Kawasaki (JP)

Correspondence Address: Patrick G. Burns, Esq., GREER, BURNS & CRAIN, LTD., Suite 2500, 300 South Wacker Dr., Chicago, IL, 60606, US

(73) Assignee: Fujitsu Limited

(21) Appl. No.: 10/794,714

(22) Filed: Mar. 5, 2004

(30) Foreign Application Priority Data
Mar. 31, 2003 (JP) 2003-095723

(51) Int. Cl. G06F 17/60

(52) U.S. Cl. 705/59

(57) ABSTRACT

An access control for confidential contents is enabled with DRM technology based on a group to which a user belongs. With a method issuing a license by a computer in response to a request to access predetermined contents with a client computer, which is made by a user who belongs to at least one of a plurality of groups, the group to which the user belongs is determined based on a user ID of a user who makes a license request via the client computer, and on a group list which is stored in a storage device and associates a user ID with a group, a license is generated by referencing a permission condition of an access control list stored in a storage device storing permission conditions based on the determined groups, and the generated license is output to the client computer.

### BACKGROUND OF THE INVENTION

1. Field of the Invention

The present invention relates to management of an access to contents, and more particularly, to management of an access to contents, which is made by a user who belongs to a plurality of groups.

2. Description of the Related Art

The present invention relates to a mechanism for safely managing a document, which is based on DRM (Digital Right Management) technology. Conventional techniques related to document management and the DRM technology are respectively cited below.

conventional technique related to document management

With a conventional document management system, a user makes a request of a document that he or she desires to use to a document management server, and downloads and uses the document. At this time, the document management server side authenticates the user, and verifies if the user is a legal user of the document. Or, at this time, the document management server side verifies if a group that can use the requested document and a group to which the user belongs match, and determines whether to permit or to reject the downloading of the document requested by the user.

General document management products include Meridio (trademark), etc. (see Document 1).

conventional technique related to the DRM technology

The DRM technology is normally a technology which protects digital contents, and distributes and manages the contents. However, the DRM technology used in this specification is defined to further indicate that contents is encoded, a permission condition for the contents and a decoding key to the contents are stored in a license, a user uses the encoded contents under the permission condition of the license after downloading the contents from a contents server, and downloading the license. This technique related to the DRM technology is disclosed by Document 2 and others.

Additionally, there are a technical paper (see Document 3) and others disclosing UDAC (Universal Distribution with Access Control), which is a DRM technological method devising of which the present inventor, et al. are involved in. These documents disclose an example where UDAC is applied to music contents, or the like.

In the association between the DRM technology and a document management system, control of printing, copy, etc. can be performed also for a document after being downloaded by linking to the document management system with Document SAFER (trademark) (see Document 4), PageRecall (trademark) (see Document 5), etc.

[Document 1]

http://software.fujitsu.com/jp/meridio/index.html

[Document 2]

Japanese Patent Publication No. 2000-305851 (Patent No. 3184190)

[Document 3]

T. Anasawa, H. Takemura, T. Tsunehiro, T. Hasebe, T. Hatakeyama: Open Superdistribution Infrastructure Realizing the Tenacity of the Content Protection, Information Processing Society of Japan, Electronic Intellectual Property/Infrastructure Technical Report, November 2001.

http://www.keitaide-music.org/pdf/EIP14-5.pdf

[document 4]

http://www.markany.co.jp/drm/sdms.html

[document 5]

http://www.authentica.com/products/pagerecall.asp

A conventional method protecting contents was implemented with access control. This is intended to perform access control for contents managed on a server side based on an access control list. With this control method, however, control cannot be performed for contents locally stored. Accordingly, control is performed only in such a way that contents can be downloaded or cannot be downloaded.

Additionally, the DRM technology is devised originally from the viewpoint of copyright protection of music contents. Therefore, this technology assumes users to be general consumers, and does not have an eye to the group management of users.

Under these circumstances, there are no types of access control for groups, which are not contradictory to permission conditions of the DRM technology, at present. Especially, if a user belongs to two or more different groups, and if permission conditions of contents vary by the respective groups, there arises a problem: it cannot be determined that a user who requests the contents receives a license under which permission condition. Additionally, control in the case where permission is desired to be made for a group, but desired to be prohibited for a certain person who belongs to that group, or vice versa is implemented only with an access control on a server side, and a control using the DRM technology for a license locally stored is not implemented under the present conditions.

### SUMMARY OF THE INVENTION

An object of the present invention is therefore to implement a group access control for confidential contents with DRM technology.

To achieve the above described object, a group to which a user belongs is determined based on an ID (identification information) of each user, and an individual license is generated based on the determined group in DRM technology.

One preferred mode of the present invention is a method issuing a license by a computer in response to a request to access predetermined contents, which is made with a client computer by a user who belongs to at least one of a plurality of groups. This method comprises: determining a group to which the user belongs based on a user ID of a user who makes a license request via the client computer, and on a group list which is stored in a storage device and associates a user ID with a group; generating a license by referencing a permission condition of an access control list stored in the storage device storing permission conditions based on the determined group; and outputting the generated license to the client computer.

This method also comprises merging permission conditions registered to the access control list, which correspond to the respective groups, with a merging rule, and generating an individual license based on the permission condition obtained by the merging, if a user belongs to a plurality of groups. More specifically, this method is characterized in that any of three rules such as 1) a rule which adopts a maximum permission condition among permission conditions of groups to which a user belongs, 2) a rule which adopts a minimum permission condition among the permission conditions of the groups to which the user belongs, and 3) a rule which puts groups into an order and adopts a permission condition based on the order is used.

According to the present invention, a group access control for confidential contents can be performed even in DRM technology. Especially, its effect is increased for the leakage of confidential information within an organization, an enterprise, etc.

### BRIEF DESCRIPTION OF THE DRAWINGS

FIG. 1 shows the outline of the generation of an individual license;

FIG. 2 shows the configuration of the present invention;

FIG. 3 shows the flow of the generation of an individual license;

FIG. 4 shows the data structure (No. 1) of a license DB;

FIG. 5 shows the data structure (No. 2) of a license DB;

FIG. 6 shows a data structure and descriptions;

FIG. 7 shows merging rules of permission conditions when a maximum permission condition is adopted;

FIG. 8 shows the flow of merging permission conditions when a maximum permission condition (and a minimum permission condition) is adopted;

FIG. 9 exemplifies results of merging permission conditions when a maximum permission condition is adopted;

FIG. 10 shows merging rules of permission conditions when a minimum permission condition is adopted;

FIG. 11 exemplifies results of merging permission conditions when a minimum permission condition is adopted;

FIG. 12 shows the flow in the case where a permission condition is adopted based on a group order;

FIG. 13 exemplifies the case where a permission condition is adopted based on a group order;

FIG. 14 shows evaluation rules when a comparison is made between an access condition specified by a user and a permission condition;

FIG. 15 shows the flow of a process for making a comparison between an access condition and a permission condition;

FIG. 16 shows a specific example of a comparison made between an access condition specified by a user and a result of merging permission conditions;

FIG. 17 exemplifies an individual license generated when a user specifies an access condition;

FIG. 18 shows the flow of generation of an individual license when a user does not specify an access condition;

FIG. 19 exemplifies an individual license generated when a user does not specify an access condition;

FIG. 20 exemplifies the linkage to a user authentication server;

FIG. 21 exemplifies the sequence of linkage to user authentication;

FIG. 22 shows a problem of control contents using a validity time limit;

FIG. 23 shows the outline of contents control implemented with a validity period;

FIG. 24 shows the flow of a process immediately after a license is stored;

FIG. 25 shows the flow of a current time checking process;

FIG. 26 shows the flow of a process executed when a license control module is activated;

FIG. 27 shows the flow of a process executed when a license is moved;

FIG. 28 shows the flow of a process executed when a license is transferred;

FIG. 29 shows the configuration of a computer according to the present invention; and

FIG. 30 exemplifies storage media from which a stored control program can be read by a computer.

### DESCRIPTION OF THE PREFERRED EMBODIMENTS

Preferred embodiments according to the present invention are described below with reference to the drawings.

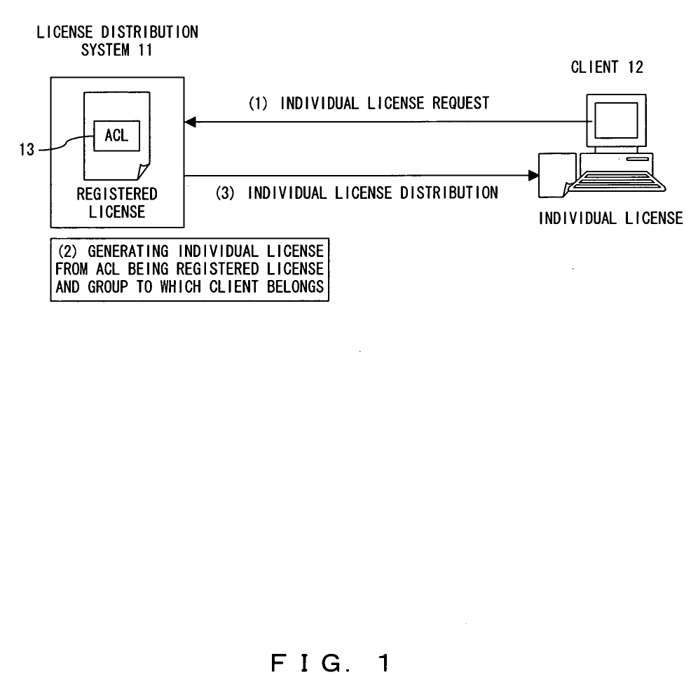

FIG. 1 shows the outline of generation of an individual license for controlling an access to contents, which is a first preferred embodiment according to the present invention, along with its system configuration.

The system comprises a license distribution system 11 and a client 12. The license distribution system comprises an ACL (Access Control List) 13.

As contents, encoded contents is assumed to be safely downloaded from a contents distribution server to the client, but this is not particularly shown here.

In FIG. 1, an ID is assigned and transmitted to each client 12 (user), and (1) a user requests an individual license. In response to this request, (2) the license distribution system 11 generates an individual license based on the ACL 13, which is a registered license, and on a group determined based on the ID, to which the client belongs. Then, (3) the license distribution system 11 distributes the individual license to the client 12.

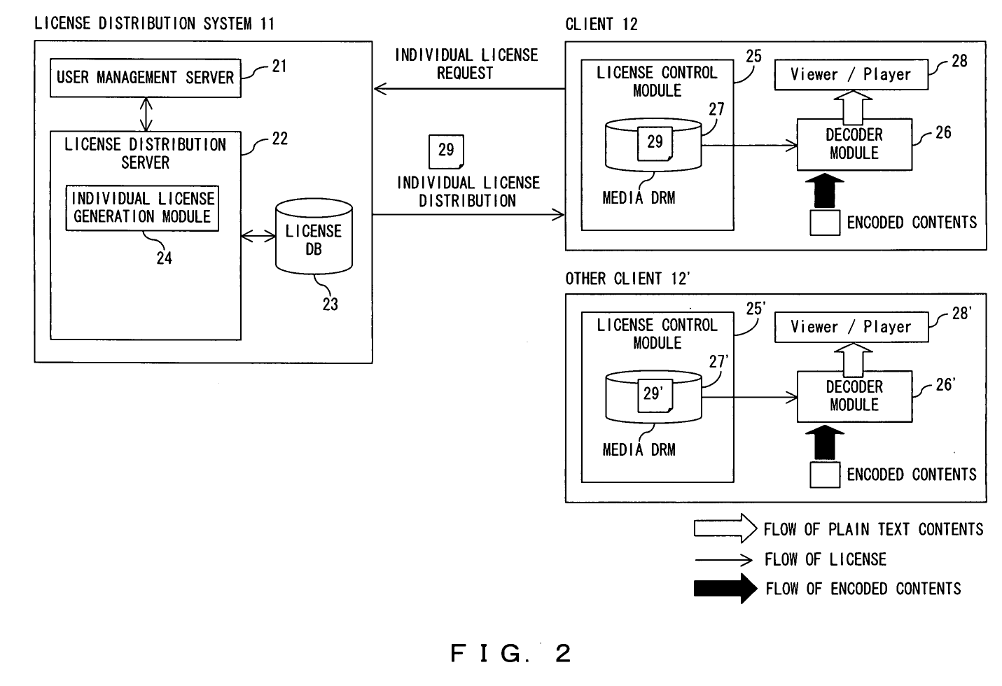

Further details of the configuration of the system according to the first preferred embodiment of the present invention are shown in FIG. 2.

The license distribution system 11 is configured by a user management server 21, a license distribution server 22, and a license database (DB) 23. The user management server 21 manages a user ID and a group to which a user belongs, and executes a process for returning a name of a group to which a user belongs when an inquiry is made with a user ID. The license DB 23 corresponds to a part managing the ACL 13, and stores permission conditions of each group and a license. The license distribution server 22 comprises an individual license generation module 24 generating an individual license.

Additionally, the client 12 is configured by a license control module 25, a decoder module 26, and a Viewer/Player 28. The license control module 25 controls operations for contents based on a license distributed from the license distribution server 22. The operations for the contents are, for example, browsing, copying, printing, etc. of an electronic document. A license 29 distributed from the license distribution server 22 is stored in a media DRM 27. The decoder module 26 receives operation information about the contents, and a decoding key to the contents from the license control module 25, and transfers the information and the key to the Viewer/Player 28. The user obtains information of the contents on a screen of a client PC, or the like with the Viewer/Player 28, namely, performs operations such as browsing, printing, etc. of an electronic document.

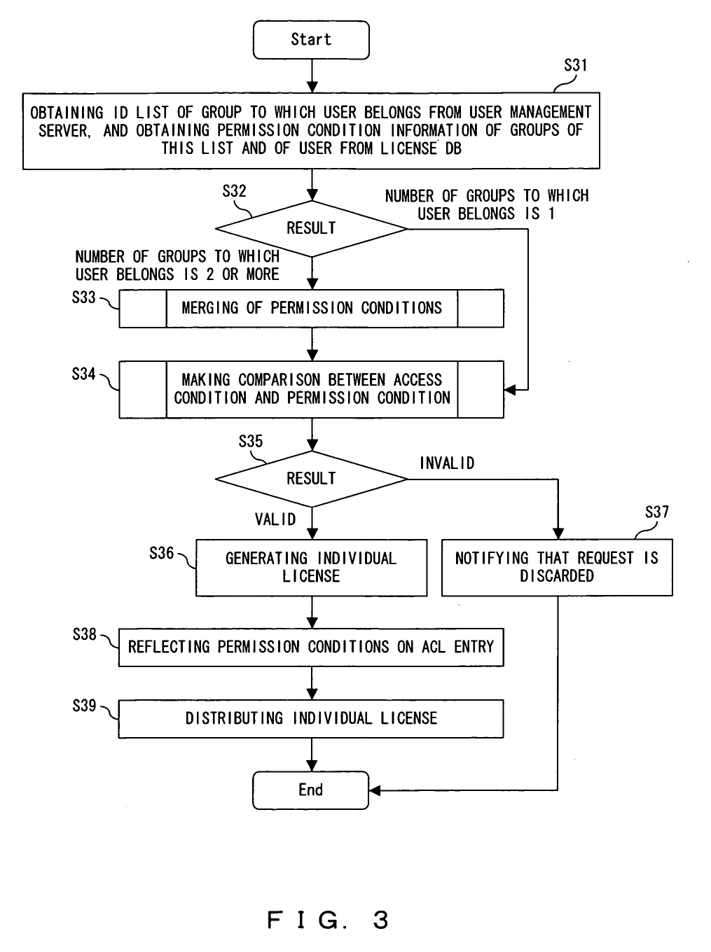

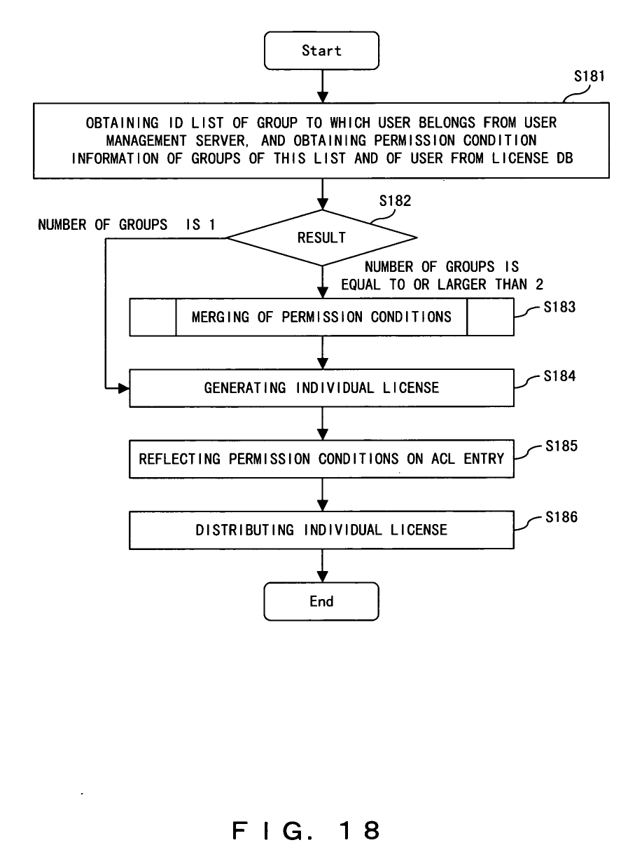

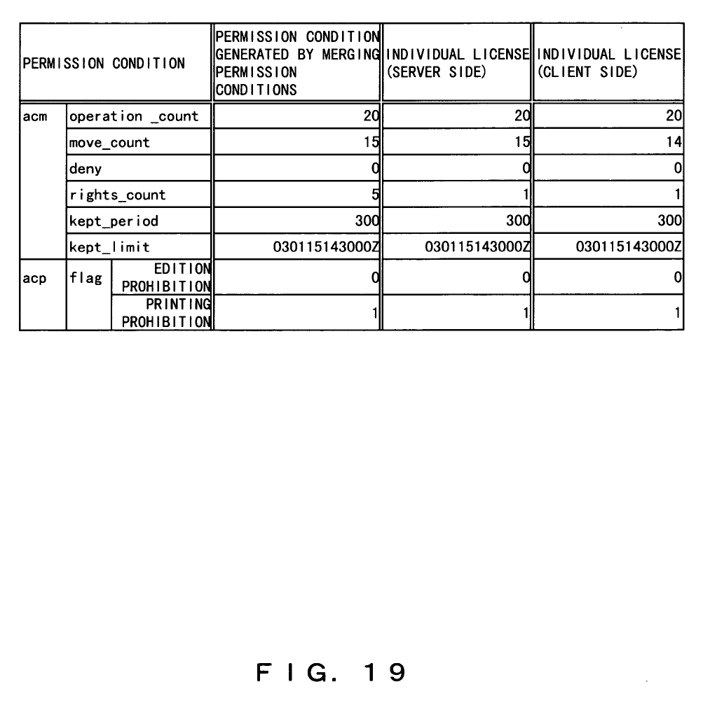

In FIGS. 1 and 2, a user can specify or unspecify a condition of an access to contents, for example, a condition that the user desires a license where the number of copy times is three, and the number of printing times is 5, when the user requests an individual license. Hereinafter, the case where a condition of an access to contents is specified is described first with reference to FIG. 3 and subsequent drawings, and the case where a condition of an access to contents is not specified is described with reference to FIGS. 18 and 19.

FIG. 3 shows the flow of generation of an individual license when a condition of an access to contents is specified.

In summary, an ACL entry of a group to which a user belongs is obtained for each entry of the ACL attached to a license managed by the license distribution system 11 to be described later, and a permission condition into which entries are merged with a merging rule is created and compared with an access condition specified by the user. If its result is valid, an individual license of the merged permission condition is generated.

Firstly, in step S31, an ID list of groups to which the user belongs is obtained from the user management server 21, and permission condition information of the groups of this list and of this user are obtained from the license DB 23. In S32, it is determined whether or not the number of groups to which the user belongs is equal to or larger than 2. If the number of groups is 1, the flow goes to step S34. If the number of groups is equal to or larger than 2, the flow goes to step S33, in which a plurality of permission conditions are merged. In step S34, a comparison is made between an access condition specified by the user and the merged permission condition. If a result of the comparison is invalid in step S35, a notification that the license request is discarded is made to the client 12 in step S37, and the process is terminated. Or, if the result of the comparison is valid in step S35, an individual license is generated in step S36, the permission condition is reflected on an ACL entry in step S38, the individual license is distributed to the client 12 in step S39, and the process is terminated. Processes in steps S33, S34, and S38 will be described in detail later.

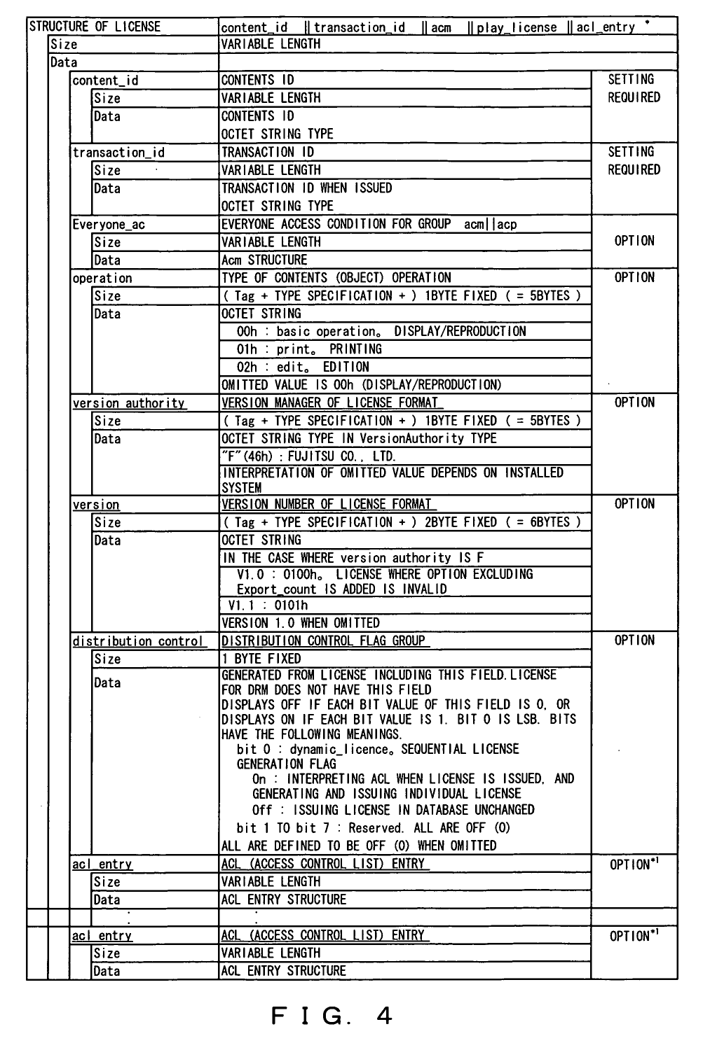

Here, the data structure of a license stored by the license DB 23 is shown in FIG. 4.

The license shown in FIG. 4 is prepared for each contents. Information required for managing a license of contents is managed. Especially, a permission condition for a user exists in acl_entry: ACL entry (ACL entry is set for each group) in the last portion of the data structure of the license.

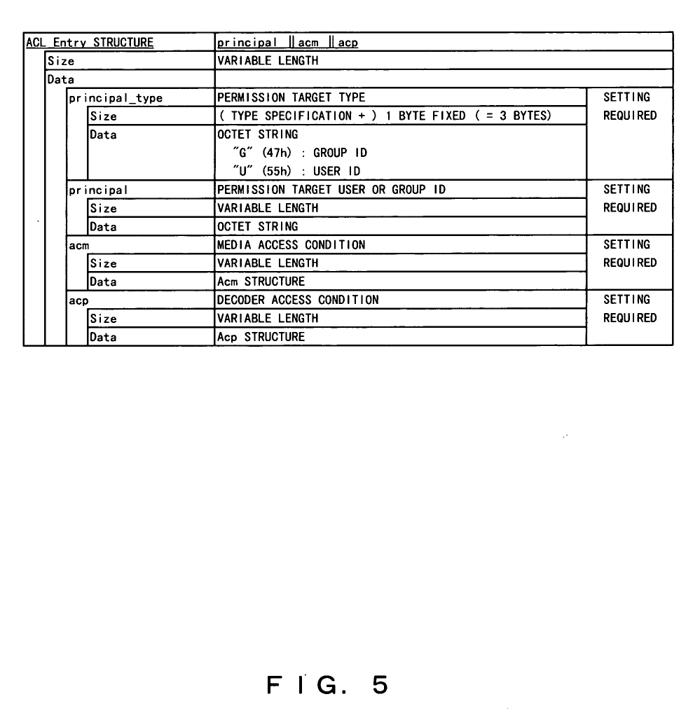

Details of the structure of acl_entry are shown in FIG. 5.

In the last portion, acm (Access Control for Media) stores a media access condition, and acp (Access Control for Player) stores a decoder access condition. An individual license is generated by referencing the acm and the acp.

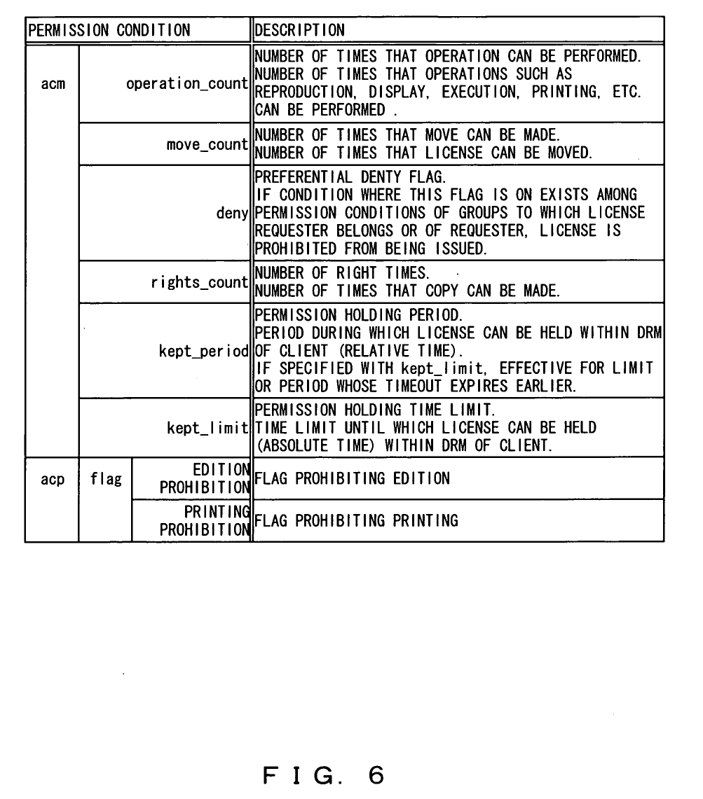

Specific examples of the permission conditions acm and acp and their descriptions are shown in FIG. 6.

The acm is composedof operation_count (the number of times that operations such as reproduction, display, execution, printing, etc. canbeperformed), move_count (the number of times that a license can be moved), deny (a preferential deny flag. If this flag is ON (=1) in any of the permission conditions of groups to which a person who requests a license belongs or of a requester, a license is not issued), rights_count (the number of rights issued, the number of times that copy (duplication) can be made, kept_period (permission holding period. A period during which a license can be held within a media DRM of a client), kept_limit (permission holding time limit. A time limit until which a license can be held within a media DRM of a client), and the like. In the meantime, a condition in the case where contents is reproduced, etc., with the Viewer/Player, and the like are stored in the acp.

The data structures of the license and permission conditions are revealed by FIGS. 4 to 6 as described above. “Merging of permission conditions” in step S33 of FIG. 3 is described in further detail with these data structures.

According to the present invention, permission conditions of respective groups are merged, for example, under the following rules if a user belongs to the plurality of groups.

(1) A maximum permission condition among permission conditions of the groups to which the user belongs is adopted.

(2) A minimum permission condition among the permission conditions of the groups to which the user belongs is adopted.

(3) The groups are put into an order beforehand, and a permission condition is adopted in that order.

The above described (1) to (3) are specifically described below.

(1) The Case Where the Maximum Permission Condition is Adopted

In this case, the maximum permission condition among the permission conditions of the groups to which the user belongs is adopted. If a permission condition for a user account is separately set, a maximum permission condition is adopted from among the conditions inclusive of the separately set condition.

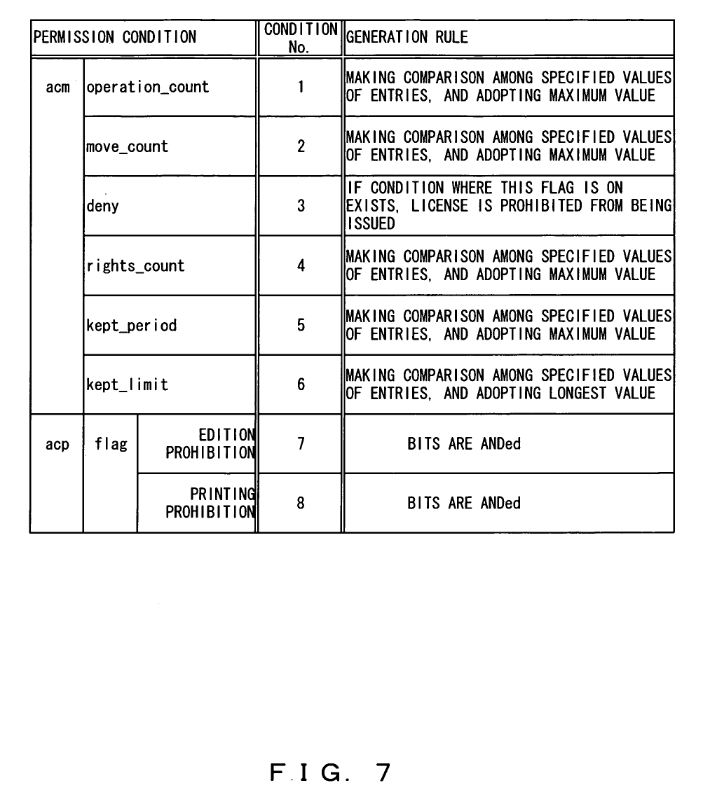

Specific rules are shown in FIG. 7.

For operation_count, move_count, rights_count, kept_period, and kept_limit of the acm, a comparison is made among specified values of respective entries, and a maximum value is adopted. Additionally, if a deny flag is set to ON, a license is not issued. For flags of the acp, their bits are ANDed. Here, condition numbers 1 to 8 are respectively assigned to the permission conditions shown in FIG. 7 (for example, the condition number of operation_count is 1), and used for a process executed when permission conditions are merged.

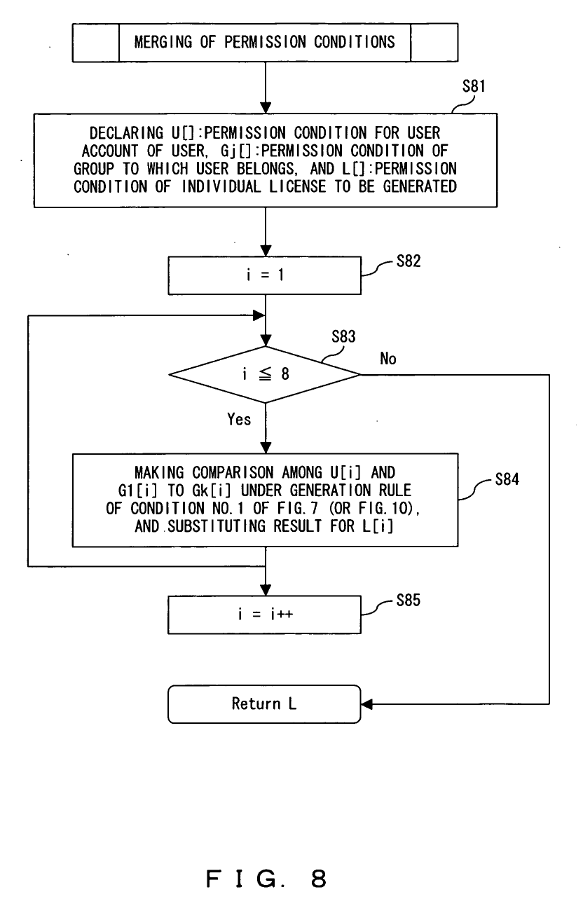

FIG. 8 shows the flow of merging permission conditions when a maximum permission condition is adopted.

Firstly, in step S81, a permission condition (U[ ]) for a user account of a user, a permission condition (Gj[ ]) of a group to which the user belongs, and a permission condition (L[ ]) of an individual license to be generated are declared. In step S82, i is initialized. i indicates a condition number. If i is equal to or smaller than 8, which is the maximum number of the condition numbers, in step S83, the flow goes to step S84. If i is larger than 8, the process is terminated. In step S84, a comparison is made among U[i], G1[i] to Gk[i] under the generation rule of the condition number i of FIG. 6, and its result is substituted for L[i]. In step S85, i is incremented, and the flow goes back to step S83. As a result of the process shown in FIG. 8, a permission condition to be obtained is acquired.

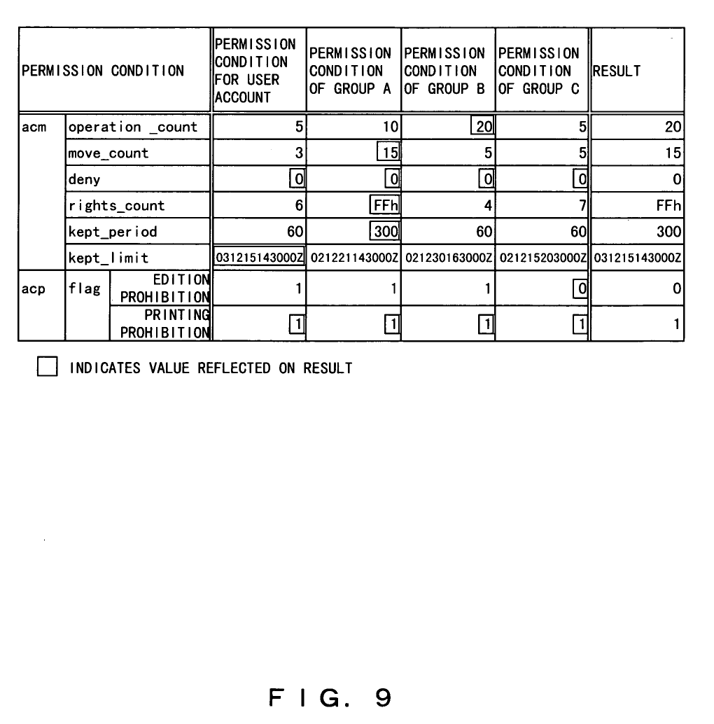

An example of a result of merging permission conditions when a maximum permission condition is adopted is shown in FIG. 9.

Assume that a user belongs to groups A, B, and C. In FIG. 9, also permission conditions for a user account are shown in addition to permission conditions of the groups A, B, and C. For example, in operation_count, the permission condition for the user account is 5, the permission condition of the group A is 10, the permission condition of the group B is 20, and the permission condition of the group C is 5. Therefore, the permission condition 20 of the group B, which is the maximum value, is adopted. Also the other permission conditions are adopted under the rules shown in FIG. 7. Values enclosed by squares in FIG. 9 indicate values reflected on results.

(2) The Case Where the Minimum Permission Condition is Adopted

In this case, the minimum permission condition among the permission conditions of the groups to which the user belongs is adopted. If a permission condition for a user account is separately set, the minimum permission condition is adopted from among the permission conditions inclusive of the separately set condition.

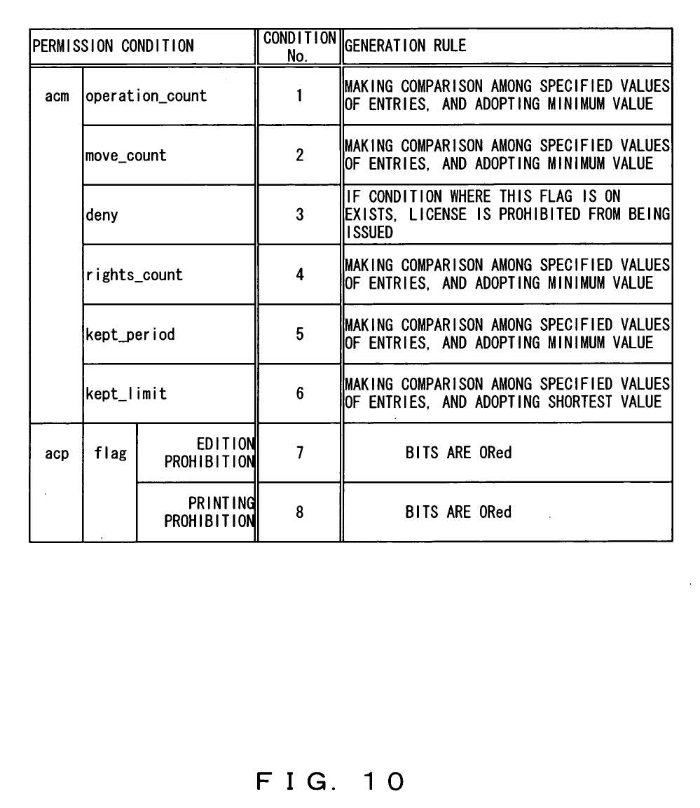

Specific rules are shown in FIG. 10.

For operation_count, move_count, rights_count, kept_period, and kept_limit of the acm, a comparison is made among specified values of respective entries, and the minimum value is adopted. Additionally, if a deny flag is set to ON, a license is not issued. For flags of the acp, their bits are respectively ORed.

The flow of merging permission conditions when the minimum permission condition is adopted is almost similar to that shown in FIG. 8 except that a comparison is made in step S84 under generation rules shown in FIG. 10. Accordingly, the flow in the case where the minimum permission condition is adopted is omitted here.

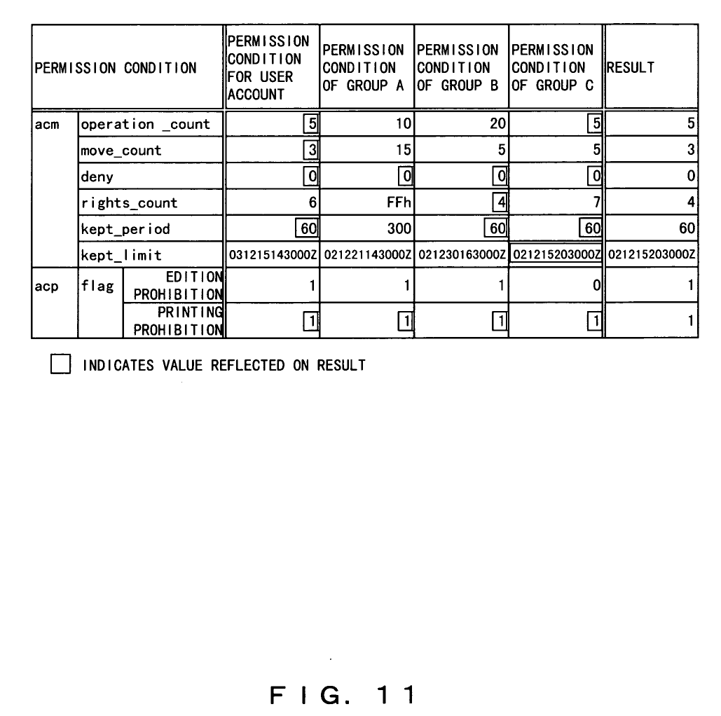

An example of a result of merging permission conditions when the minimum permission condition is adopted is shown in FIG. 11.

Assume that a user belongs to groups A, B, and C. In FIG. 11, also permission conditions for auser account are shown in addition to permission conditions of the groups A, B, and C. For example, in operation_count, the permission condition for the user account is 5, the permission condition of the group A is 10, the permission condition of the group B is 20, and the permission condition of the group C is 5. Therefore, the minimum permission condition 5, which is the permission condition for the user account and that of the group C, is adopted. Also the other permission conditions are adopted under the rules shown in FIG. 10. Values enclosed by squares in FIG. 11 indicate values reflected on results.

(3) The Case Where a Permission Condition is Adopted in a Preassigned Group Order.

An order in which permission conditions of groups to which a user belongs, and those for a user account are adopted is predetermined, and a comparison is made with an access condition specified by a user in that order. If a result of the comparison is valid, an individual license is generated under that permission condition. If the result of the comparison is invalid, a comparison is made with a permission condition of the next order.

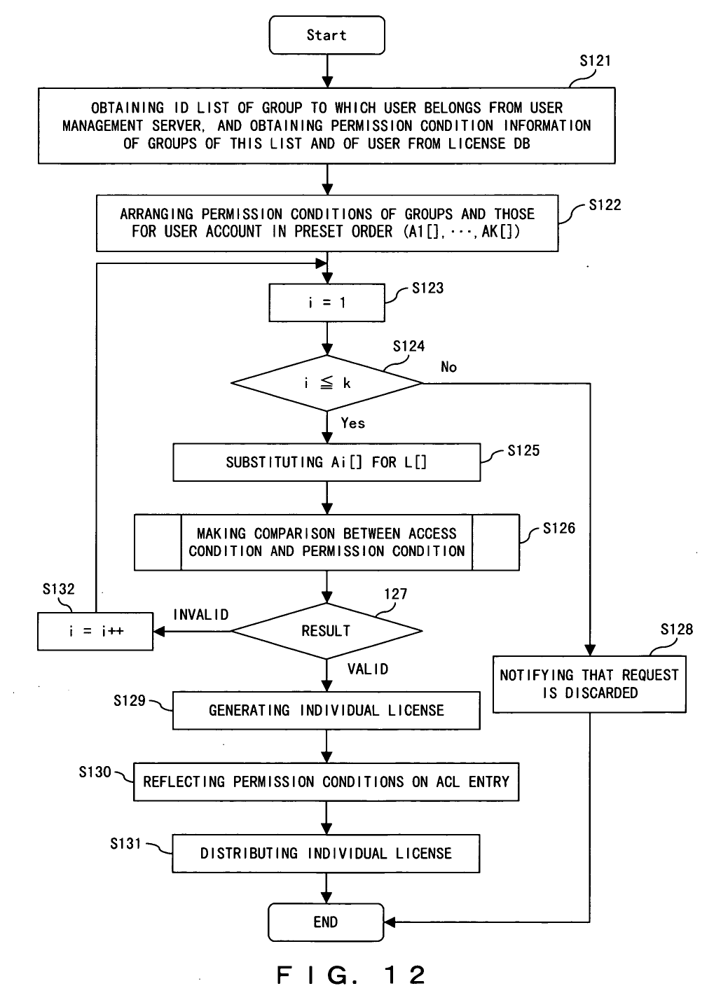

In this case, only step S33 of FIG. 3, in which permission conditions are merged, does not function as in (1) and (2). Therefore, an improved version of the flow shown in FIG. 3 is depicted in FIG. 12.

Steps S121, S126, S128, S129, S130, and S131 in this figure respectively correspond to steps S31, S34, S37, S36, S38, and S39 of FIG. 3. For their detailed description, see the description of FIG. 3.

In FIG. 12, in step S121, an ID list of groups to which a user belongs is obtained from the user management server, and permission condition information of the groups of this list and of the user are obtained from the license DB. In step S122, permission conditions of the groups and those for the user account are arranged in a preset order (A1[ ], . . . , Ak[ ]). In step S123, i is initialized. If i is equal to or smaller than k in step S124, the flow goes to step S125. If i is larger than k, a notification that a license request is discarded is made to the client in step S128, and the process is terminated. In step S125, Ai [ ] is substituted for a permission condition result L[ ]. In step S126, a comparison is made between an access condition specified by the user and the permission condition result L[ ]. If a result of the comparison is valid in step S127, the flow goes to step S129. If the result of the comparison is invalid, i is incremented in step S132, and the flow goes back to step S124. In step S129, an individual license is generated. In step S130, the permission condition is reflected on an ACL entry. In step S131, the generated individual license is distributed to the client, and the process is terminated.

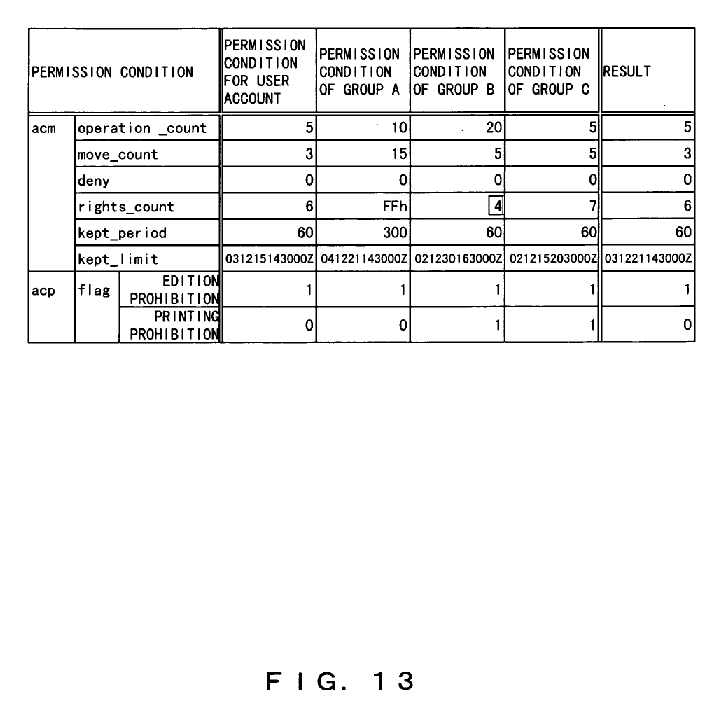

A specific example in the case where permission conditions are adopted in a preassigned group order is shown in FIG. 13.

Here, assume that all of groups are A, B, C, D, E, F, and G, a permission condition for a user account is U, and an order where permission conditions are adopted is U→B→G→A→E→C→D→F. Since the user belongs to the groups A, B, and C, permission conditions of the groups A, B, and C are shown in FIG. 13. Additionally, access conditions specified by the user are shown in the leftmost column. Permission conditions for the user account are assumed not to be particularly set here.

An order where the permission conditions are adopted is U→B→ . . . , and no permission conditions for the user account are set. Therefore, a comparison is made between the permission conditions of the group B next to the group U and the access conditions specified by the user (although details of the comparison between an access condition and a permission condition will be described later as a description of step S34 of FIG. 3, they are roughly described with a specific example here). The permission conditions such as operation_count, move_count, deny, and rights_count of the group B are respectively 20, 5, 0, and 4, and the access conditions specified by the user are 5, 3, 0, and 6. rights_count of the group B, namely, the number of rights issued of the group B, which can be permitted, is only 4. However, since the user requests rights_count 6 as an access condition, a comparison result becomes invalid. Therefore, a comparison is made with the permission conditions of the next group.

When the next permission conditions are adopted, a comparison is made between the permission conditions of the group A and the access conditions specified by the user. This is because the order in which the permission conditions are adopted is . . . B→G→A . . . . The permission conditions such as operation_count, move_count, deny, rights_count, kept_period, and kep_limit of the group A are respectively 10, 15, 0, FFh (indicating infinity), 300, and 041221143000Z, whereas the access conditions specified by the user are respectively 5, 3, 0, 6, 60, and 031215143000Z. Because the access conditions specified by the user satisfy the values of the group A, which can be permitted, and also satisfy the permission conditions of acp. Therefore, the permission conditions of the group A are adopted, and an individual license is generated under the access conditions specified by the user.

Up to this point, the merging of permission conditions in step S33 of FIG. 3 is described in detail with the specific example.

The comparison made between an access condition specified by the user and a permission condition in step S34 of FIG. 3 is described in detail next.

In this comparison, it is determined whether or not an access condition specified by the user is satisfied. “specified access condition is satisfied” indicates a case which corresponds to none of the following cases.

A case where a specified number of times is larger than the number of times, which is obtained by a merging rule, for a condition of the number of times of printing, browsing, etc.

A case where a specified condition requires permission, and a condition obtained by a merging rule is not permitted for a condition of permission/non-permission of a right such as editing, etc.

A case where a time limit of a specified condition is longer than that of a merged condition for a condition of a period such as a validity time limit, etc.

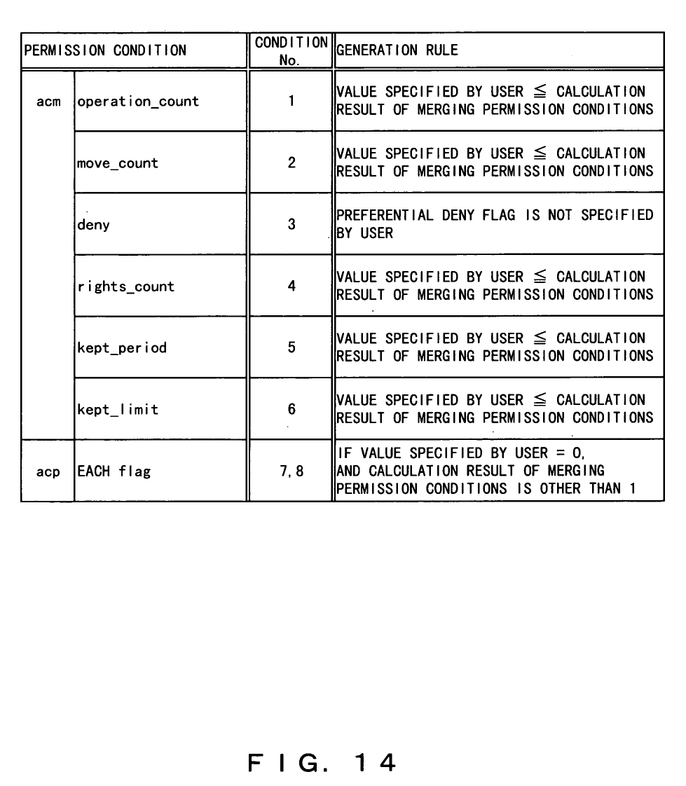

Specifically, the comparison is made under evaluation rules shown in FIG. 14.

operation_count, move_count, rights_count, and kept_period become valid if a value specified by a user is equal to or smaller than each value resultant from merging permission conditions. Additionally, respective flags become valid if a value specified by a user is 0, and if the result of merging permission conditions is other than 1. Furthermore, since a deny flag is not particularly specified from the user, a comparison is not made. However, if the deny flag is ON, an individual license is not issued.

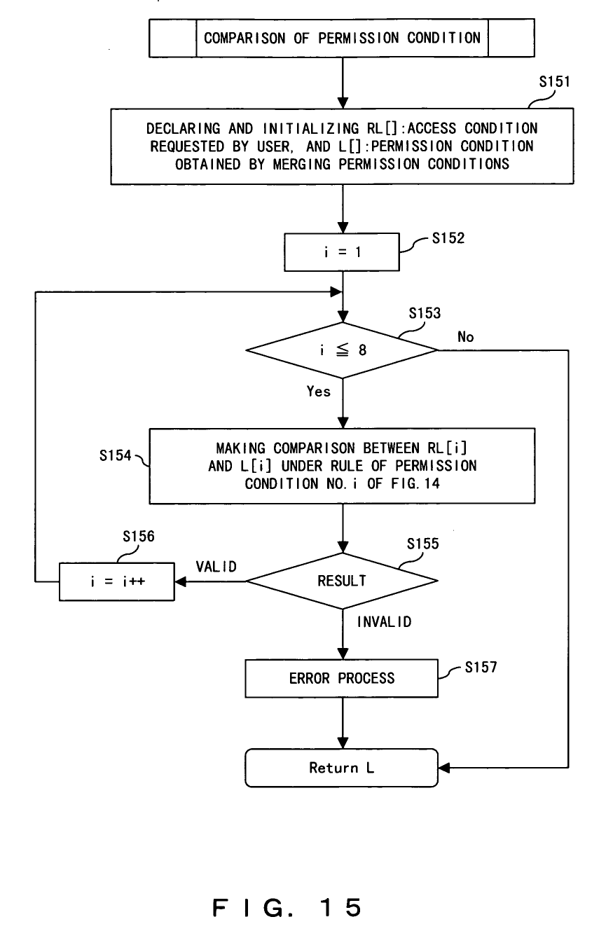

A process for making a comparison between an access condition specified by the user and a permission condition is executed under the evaluation rules for the comparison shown in FIG. 14. The flow of this comparison process is shown in FIG. 15.

In step S151, an access condition (RL[ ]) requested by a user, and a permission condition (L[ ]) obtained as a result of merging permission conditions are declared and initialized. In step S152, i is initialized. In step S153, it is determined in step S153 whether or not i is equal to or smaller than 8, which is the maximum value of the condition numbers. If i is equal to or smaller than 8, the flow goes to step S154. If i is larger than 8, the process is terminated. Termination of this process means that the results of the comparisons of the permission conditions having the numbers 1 to 8 are valid. In step S154, a comparison is made between RL[i] and L[i] under the rule of a condition number i in FIG. 14. If a result of the comparison is valid in step S155, i is incremented in step S156, and the flow goes back to step S153. If the result of the comparison is invalid in step S155, the flow goes to step S157, in which an error process is executed. Here, the process is terminated. If the error process is executed, this means that a determination of rejecting the permission is made for any of the condition numbers 1 to 8. In this case, an individual license is not issued.

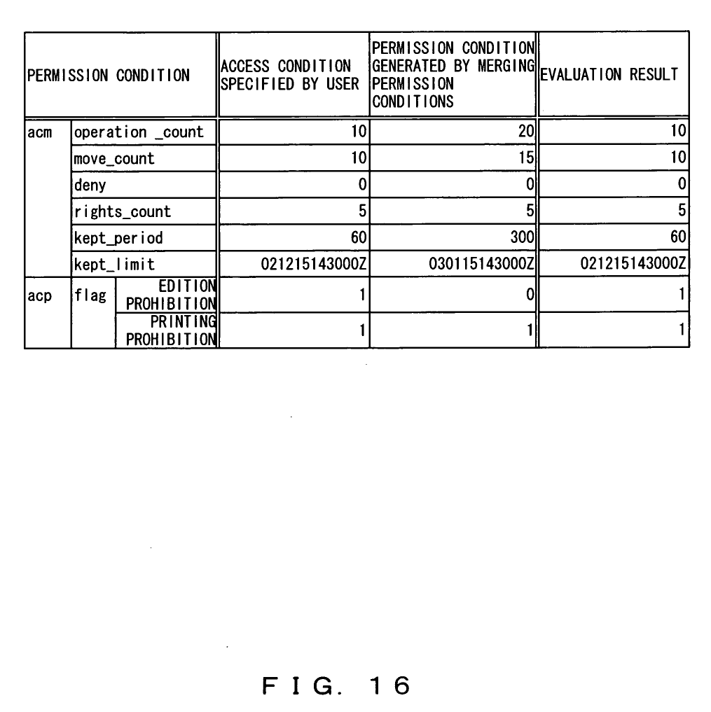

A specific example of the comparison made between access conditions specified by a user and results of merging permission conditions is shown in FIG. 16.

The results of merging permission conditions are obtained as follows: oeration_count, move_count, rights_count, kept_period, and kept_limit are respectively 20, 15, 5, 300, and 03115143000Z, and the access conditions specifiedbytheuser are respectively 10, 10, 5, 60, and 02121514300Z. Since allofthe results of merging permission conditions are equal to or larger than the values of the access conditions specified by the user, the values of the access conditions specified by the user become valid and are obtained as evaluation results (the rightmost column) . Because a deny flag is not ON (=1), an individual license is generated. Also for flags, all of them are determined to be valid under the evaluation rules shown in FIG. 14, and evaluation results are therefore obtained.

Up to this point, the comparison between the access conditions specified by the user and the permission conditions in step S34 of FIG. 3 has been described in detail.

The reflection of permission conditions on an ACL entry in step S38 of FIG. 3 is described in detail next.

This is the execution of a process for subtracting a requested number of access conditions specified by a user from the number of rights issued (the number of copy times) in an ACL entry of a group, which is adopted under the permission condition merging rules after an individual license is generated. Namely, the number of rights issued for a group is predetermined, and the number of rights issued, which is given to a user, is subtracted in an ACL on the server side the same time an individual license is generated, so that the number of rights issued when an individual license is generated can be managed later.

Generation of an individual license on the server side is equivalent to copying of a license. Therefore, a requested number specified by the user is subtracted from rights_count of a group adopted as a permission condition for rights_count in the ACL entry. Specifically, the permission conditions of the group A are adopted in the example shown in FIG. 13. Therefore, a requested number specified by the user, 6 in this case, is subtracted from the value “FFh” of rights_count of the group A. However, since “FFh” indicates infinity in rights_count, inifinity is assumed to remain unchanged even if subtraction is made.

Additionally, if an individual license generated by the server is distributed and passed to the client, this can be recognized as one move. Actually, the individual license where 1 is subtracted from move_count is passed to the client.

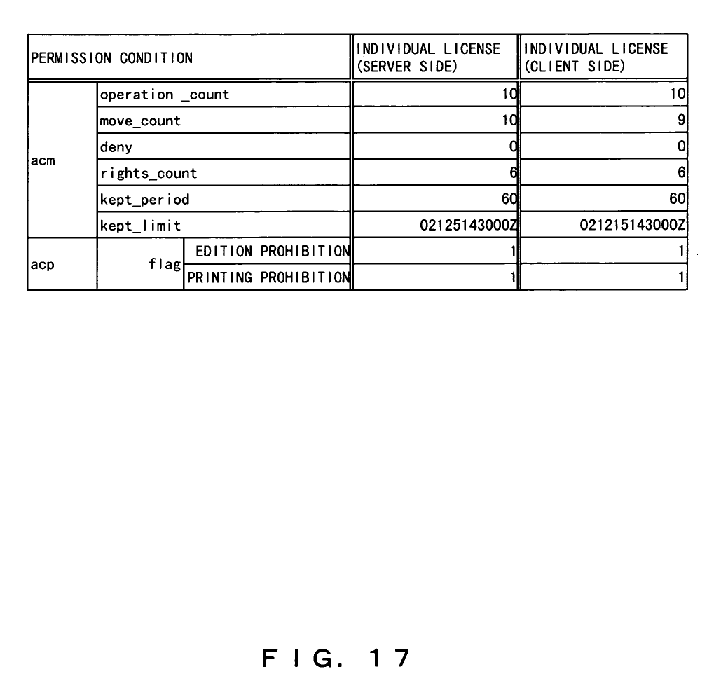

An example of an individual license is shown in FIG. 17.

An individual license generated on the server side, and that passed to the client are respectively shown in the left and the right columns move_count of the individual license on the server side is 10, whereas that of the individual license passed to the client is 9.

As described above, in the process of step S38, the reflection on the number of rights issued in an ACL, and the reflection on the number of times that an individual license passed to the client is moved are made on the server side.

Up to this point, the process executed in the case where a user specifies conditions of an access to contents when he or she requests an individual license is described with reference to FIGS. 3 to 17.

The case where a user does not specify conditions of an access to contents is described next with reference to FIGS. 18 and 19.

If the user does not specify conditions of an access to contents, the following two points are different from the case where the user specifies access conditions.

There is no process for making a comparison between access conditions and permission conditions.

Subtracting 1 from the number of rights issued (copy times) in an entry of an adopted group when permission conditions are reflected on the ACL entry.

The flow of generation of an individual license when a user does not specify access conditions is shown in FIG. 18.

Firstly, in step S181, an ID list of groups to which the user belongs is obtained from the user management server 21, and permission condition information of groups of this list and of the user are obtained from the license DB 23. In step S182, it is determined whether or not the number of groups to which the user belongs is equal to or larger than 2. If the number of groups is 1, the flow goes to step S184. If the number of groups is equal to or larger than 2, the flow goes to step S183, in which a plurality of permission conditions are merged. In step S184, an individual license is generated. In step S185, permission conditions are reflected on an ACL entry. In step S186, the individual license is distributed to the client 12. Here, the process is terminated. Details of the respective processes correspond to those of FIG. 3. However, if the user does not specify access conditions, an individual license where rights_count is 1 is generated in the generation of an individual license in step S184. This means that copying of contents is permitted only once for a client to which the contents is distributed if the user does not specify access conditions. In this case, 1 is subtracted from rights_count of the group whose permission conditions are adopted in the reflection of permission conditions on an ACL entry in step S185. Additionally, when the individual license is passed to the client, the license where 1 is subtracted from move_count is distributed.

An example of an individual license in the case where the client does not specify access conditions is shown in FIG. 19.

A permission condition obtained as a result of merging permission conditions, an individual license generated on the server side, and an individual license passed to the client are respectively shown in the left, the middle, and the right columns rights_count of the individual licenses are 1 both on the server and the client sides. Additionally, move_count is 15 on the server side, whereas that is 14 on the client side. For the other conditions, values of permission conditions, which are obtained as a result of merging permission conditions, are reflected on the individual licenses unchanged.

Up to this point, the first preferred embodiment according to the present invention is descried in detail. This preferred embodiment, however, requires the function for authenticating a user when the user requests the generation of an individual license. Accordingly, one example of the general linkage between a user authentication server and the license distribution system according to the present invention is described below.

The linkage between the downloading of a license, namely, a license request and user authentication is implemented by a flow such that whether or not a user is authenticated is verified (hereinafter referred to as authentication verification) when a license is downloaded, a group ID list is obtained from the user management server, and an individual license is generated and distributed if the user is authenticated.

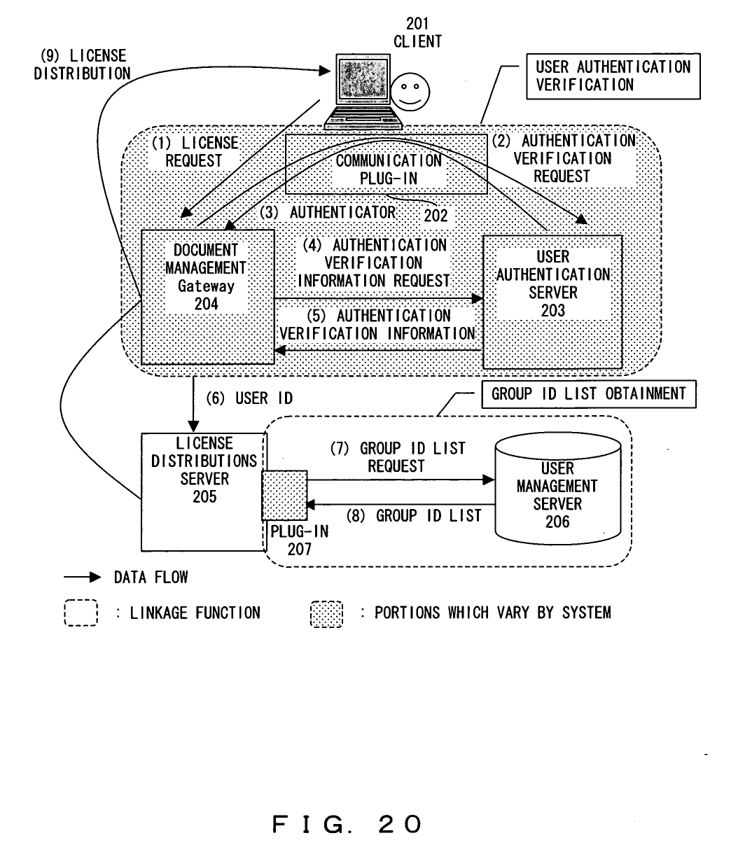

An example of the linkage to the user authentication server is shown in FIG. 20.

User authentication verification is made by a communication plug-in 202, a user authentication server 203, and a document management Gateway 204. If the user has been authenticated, a group ID list is obtained from a user management server 206, an individual license is generated by a license distribution server 205, and the generated license is distributed to a client 201 via the document management Gateway 204.

In FIG. 20, (1) a license request is transmitted from the client 201 to the document management Gateway 204. (2) The document management Gateway 204 requests the user authentication server 203 to make user authentication verification via the communication plug-in 202. (3) The user authentication server 203 transmits an authenticator to the document management Gateway 204, and (4) the document management Gateway 204 makes an authentication verification information request to the user authentication server 203. (5) The user authentication server 203 transmits authentication verification information to the document management Gateway 204. Up to this point, the user authentication verification has been made. Then, (6) a user ID is transmitted to the license distribution server 205, and (7) a request of a group ID list is made to the user management server 206 via a plug-in 207 of the license distribution server. (8) The user management server 206 transmits the group ID list to the license distribution server plug-in 207. (9) The license distribution server 205 generates an individual license based on the received group ID list, and distributes the generated license to the client.

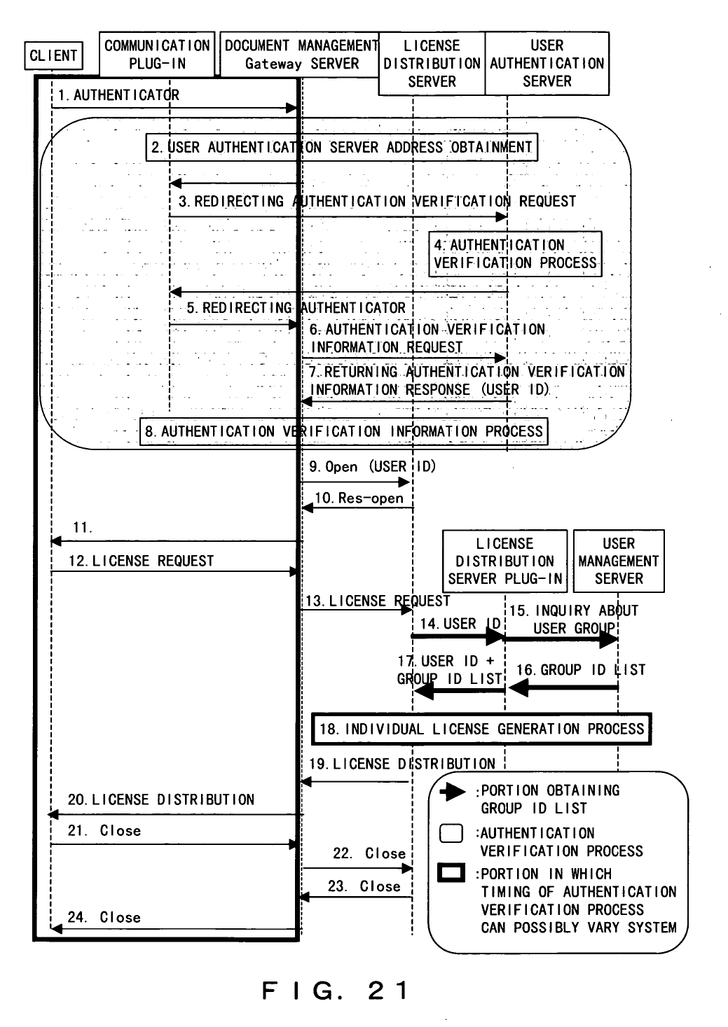

A sequence of the example of the linkage to the user authentication is shown in FIG. 21.

A shaded portion of the sequence shown in FIG. 21 is a user authentication verification process, which is a portion varying by an original system.

1. The client makes a request of user authentication verification to the document management Gateway. At this time, a user ID is passed. After this request, a socket of a communication of the client is open only for the document management Gateway until the document management Gateway completes the authentication verification, and a license request cannot be made to the license distribution server.

2. The document management Gateway obtains an address of the user authentication server.

3. The document management Gateway redirects the request of authentication verification to the user authentication server via the communication plug-in.

4. The user authentication server executes an authentication verification process.

5. The user authentication server redirects an authenticator to the document management Gateway via the communication plug-in.

6. The document management Gateway makes a request of authentication verification information to the user authentication server.

7. The user authentication server makes a response of the authentication verification information along with a user ID.

8. The document management Gateway executes an authentication verification information process. Namely, the matching of the user ID obtained in 1. and the user ID stored in the obtained authentication verification information is verified.

9. The document management Gateway passes the socket of the communication of the client to the license distribution server. Namely, the client can communicate with the license distribution server. At this time, the license distribution server interprets the version of a protocol from the request message of the client, and makes a subsequent communication with the client with the protocol version conforming to the interpreted protocol. If the protocol version of the client is not supported on the server side, the server notifies the client of an error message.

10. The license distribution server returns a response of 9. to the document management Gateway.

11. The document management Gateway notifies the client that the socket of the communication is passed to the license distribution server.

12.13. The client makes a request of a license to the license distribution server.

14.15. The license distribution server makes an inquiry about a group of the user to the user management server via the license server plug-in.

16.17. The user management server returns a group ID list and a user ID to the license distribution server.

18. An individual license is generated based on the user ID, the group ID list, and an ACL.

19.20. The license distribution server distributes the license to the client via the document management Gateway.

21.22.23.24. The socket of the communication is closed (Close).

Up to this point, the first preferred embodiment according to the present invention is described in detail.

The first preferred embodiment refers to the method managing an access to confidential contents by using an individual license. When contents and an individual license, which are distributed from the server, are downloaded into the client, and the contents is controlled by the client, it is considered that a malicious user, etc. changes the substantial validity period of the contents by intentionally changing a clock (hereinafter referred to as local time) included in a client PC (personal computer) to illegally use the contents.

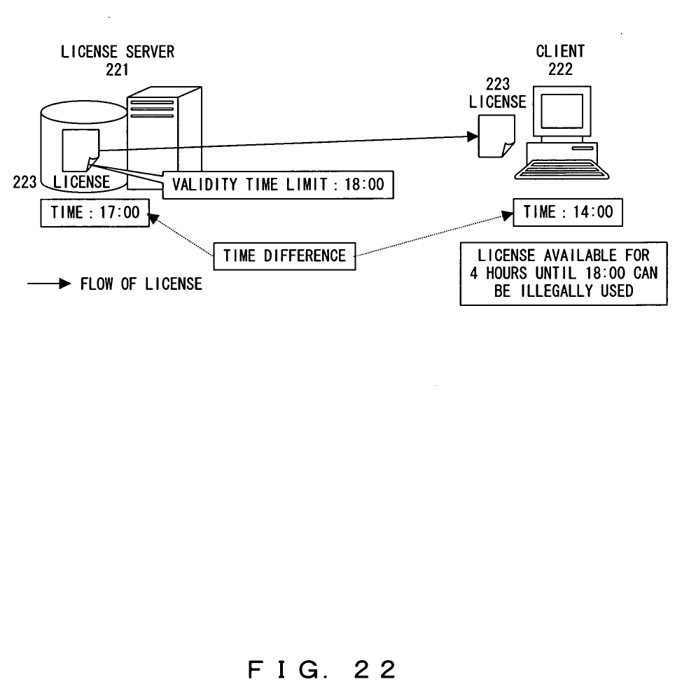

Its example is shown in FIG. 22.

In FIG. 22, a license 223 the validity time limit of which is up to 18:00 is issued from a license server 221 at the current time 17:00, and distributed to a client 222. In the client 222, its local time is set to 14:00. Therefore, the contents which is originally available only for one hour from 17:00 to 18:00 becomes illegally available for 4 hours from 14:00 to 18:00.

To solve such a problem, a method controlling confidential contents based on a validity period such as 1 hour, 5 minutes, etc. instead of a validity time limit is described below as a second preferred embodiment according to the present invention.

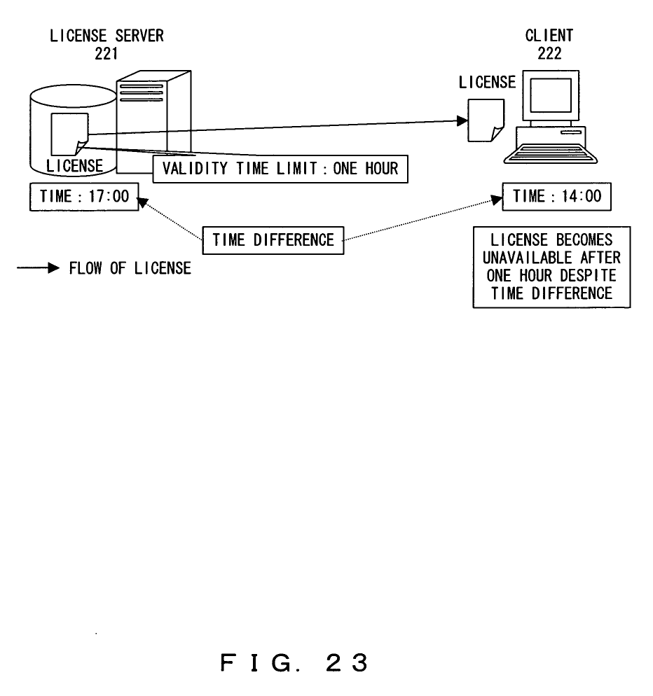

Outline of contents control using a validity period, which is the second preferred embodiment according to the present invention, is shown in FIG. 23 along with its system configuration.

The system comprises a license server 221 issuing a license, and a client 222 receiving contents and a license and controlling the contents. In FIG. 23, the time of the license server 221 is 17:00, whereas the local time of the client 222 is 14:00, which is different from the time of the license server 221. However, since the validity period of the license is issued to be 1 hour, the contents becomes unavailable in the client 222 after 1 hour from when the contents is downloaded, even if a time difference exists between the current time and the local time.

Further details of the system configuration according to the second preferred embodiment of the present invention are the same as those of FIG. 2 which shows the system configuration of the first preferred embodiment. Namely, the license server 221 comprises a function for issuing a license, and the client 222 comprises a license control module 25, a decoder module 26, and a Viewer/Player 28. A license 29 distributed from the license server is stored in a media DRM 27. The license control module 25 controls contents operations based on a license. In this preferred embodiment, the license control module 25 comprises process functions to be described below in order to implement a control using a validity period.

1. a process immediately after a license is stored when the license arrives

2. a current time checking process

3. a process executed when the license control module is activated

4. a process executed when a license is moved

5. a process executed when a license is transferred

The above described processes 1 to 5 are sequentially described below.

1. A Process Immediately after a License is Stored when the License Arrives

When a license arrives at the license control module of the client PC from the license server, a time obtained by adding a validity period to a time at which the license arrives (local permission holding time limit=license arrival time+permission holding period) is safely processed and recorded so as not to be falsified as a local validity time limit.

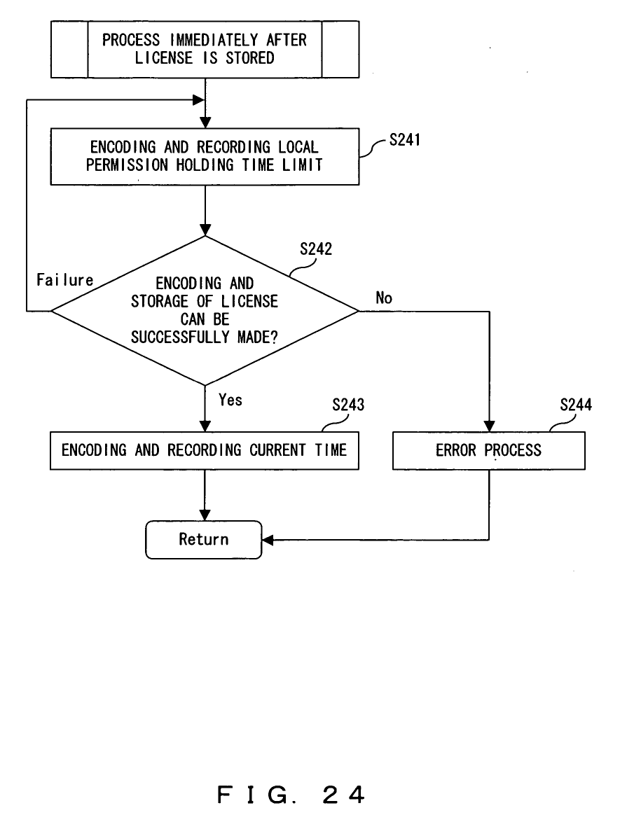

The flow of the process immediately after a license is stored is shown in FIG. 24.

Firstly, in step S241, a local permission holding time limit is encoded and recorded. In step S242, it is determined whether or not encoding and storage of the license are successfully made. If the encoding and the storage are unsuccessfully made (Failure), the flow goes back to step S241. If the encoding and the storage are successfully made (Yes), the flow goes to step S243. Or, if the encoding and the storage of the license cannot be made despite being retried several times (No), an error process is executed in step S244, and the process is terminated. In step S243, the current time is encoded and stored.

2. The Current Time Checking Process

The current time checking process is a process for checking whether or not the current time of the client is a time before the most recently recorded time. If the current time is a time before the most recently recorded time, all of licenses for which permission holding periods are set are invalidated.

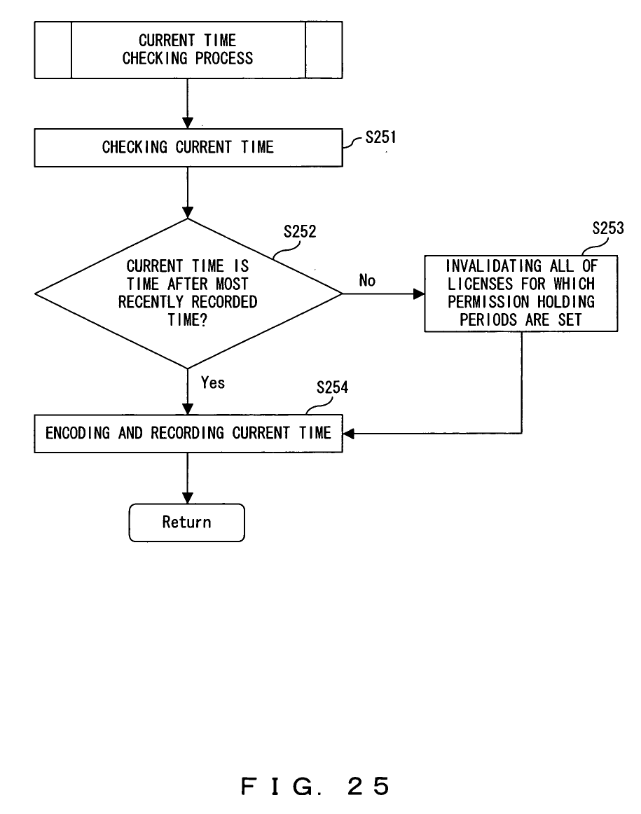

The flow of the current time checking process is shown in FIG. 25.

In step S251, the current time is checked. In step S252, it is determined whether or not the current time is a time after the most recently recorded time. If the current time is a time after the most recently recorded time (Yes), the flow goes to step S254, in which the current time is encoded and recorded, and the process is terminated. If the current time is a time before the most recently recorded time (No), the flow goes to step S253, in which all of licenses for which permission holding periods are set are invalidated, and the flow goes to step S254. Here, the process is terminated.

3. The Process Executed when the License Control Module is Activated

Firstly, a process for checking the local validity time limit of a license, which is already recorded, and for deleting a license whose validity time limit expires is executed when the license control module is activated. Then, whether or not the local time is put back is determined with a process similar to the current time checking process when the license control module is activated.

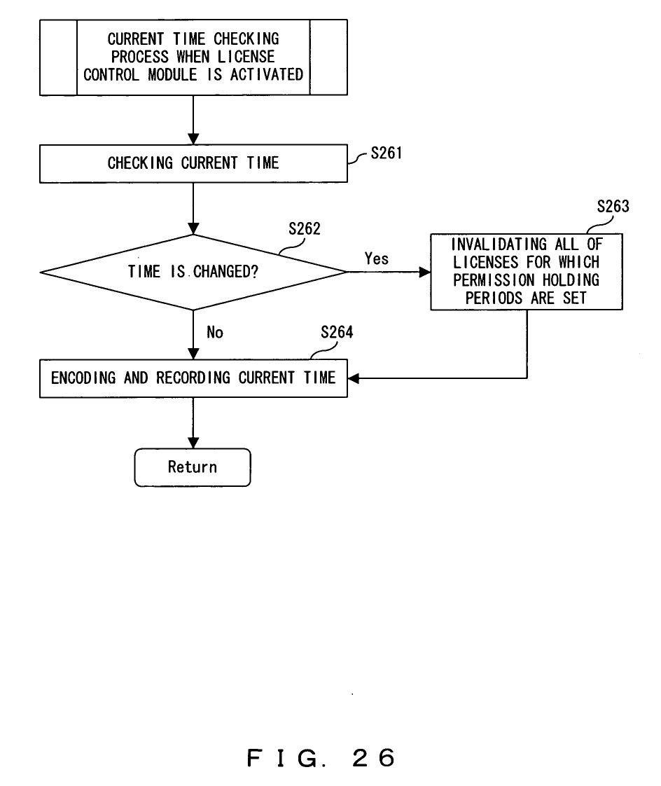

The flow of the current time checking process executed when the license control module is activated is shown in FIG. 26.

In step S261, the current time is checked. In step S262, it is determined whether or not the time is changed. If the time is changed (Yes), the flow goes to step S263, in which all of licenses for which permission holding periods are set are invalidated. If the time is not changed (No), the flow goes to step S264, in which the current time is encoded and stored, and the process is terminated.

4. The Process Executed when a License is Moved

The move of a license means that a license is transmitted to a decoder module in order to reproduce contents.

When a license is transmitted to the decoder module, a process for making a determination of whether or not the current time is before a local permission holding time limit (hereinafter referred to as local permission holding time limit checking), and for not moving a license if the current time is not before the holding time limit is executed.

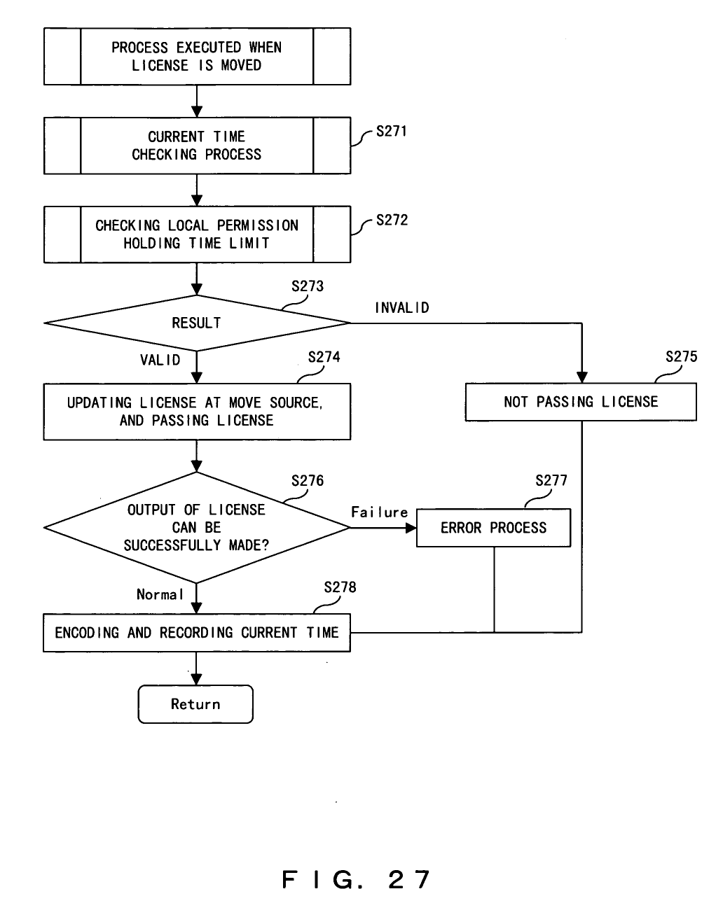

The flow of the process executed when a license is moved is shown in FIG. 27.

Firstly, in step S271, the current time checking process described in 2. is executed. In step S272, a determination of whether or not the current time is before a local permission holding time limit is made. If the period is valid as a result of the determination made in step S273, the flow goes to step S274. If the period is invalid, the flow goes to step S275, in which a license is decided not to be passed. In step S274, the license at the move source, namely, the license stored in the media DRM is updated, and passed to the decoder module. The update of a license stored in the media DRM means that 1 is subtracted from the number of times (operation_count in the example of FIG. 6) that contents can be operated, and from the number of rights issued (rights_count in the example of FIG. 6). Namely, this means that the use of contents once is reflected on the license. In step S276, whether or not the output of the license is successfully made is determined. If the output is successfully made (Normal), the flow goes to step S278, in which the current time is encoded and recorded. Here, the process is terminated. If the output is unsuccessfully made (Failure), the flow goes to step S277, in which an error process is executed. The flow then goes to step S278, and the process is terminated.

5. The Process Executed when a License is Transferred

The transfer of a license means that a license is moved/copied to a media DRM of a different client PC (12 of FIG. 2).

When a request to transfer a license is made from a different client PC, the current time checking process is executed, and a process for making local permission holding time limit checking, for calculating a permission holding remaining period (permission holding remaining period=permission holding period−time stored in the media DRM at a move source), and for transferring a license in which the calculated value is substituted for the permission holding period is executed.

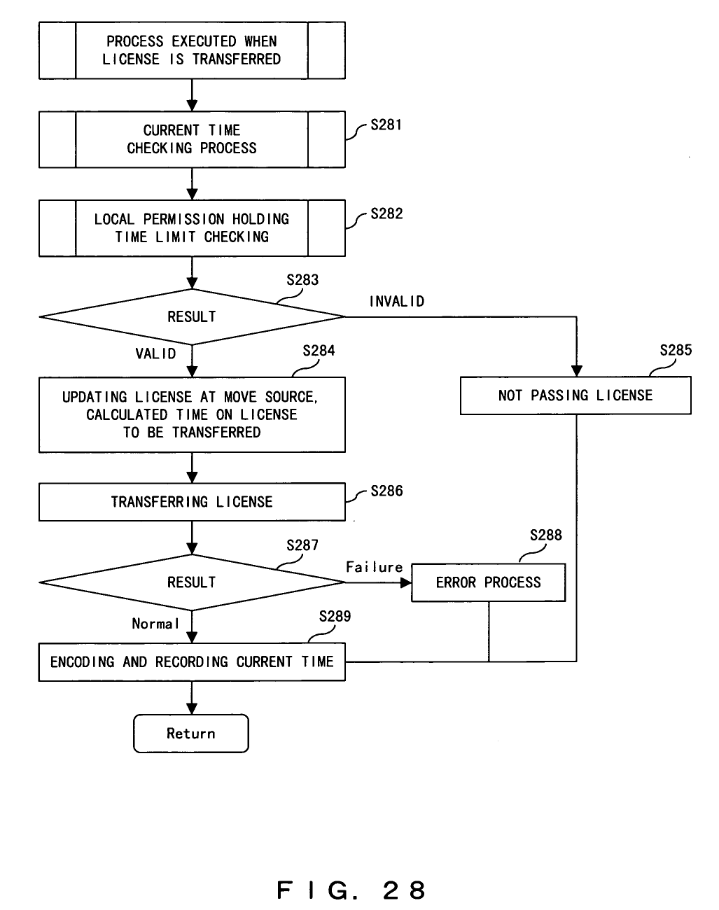

The flow of the process executed when a license is transferred is shown in FIG. 28.

In step S281, the current time checking process, which is described in 2., is executed. In step S282, it is determined whether or not the current time is before the local permission holding time limit. If the period is valid as a result of the determination made in step S283, the flow goes to step S284. If the period is invalid, the flow goes to step S285, in which a license is decided not to be passed. In step S284, the license at the move source is updated, and a permission holding remaining time is calculated and reflected on the license to be transferred. The update of the license at the move source means that 1 is subtracted from the number of rights issued (rights_count in the example of FIG. 6), and the number of times moved (move_count in the example of FIG. 6) in the license at the move source, for example, when the license where the number of rights issued is 1 is transferred. In the case of this example, the license where the number of rights issued is 1, the number of times moved is 0, and the other conditions are the same as those of the license at the move source is transferred to a move destination. Then, in step S286, the license is transferred. In step S287, it is determined whether or not the transfer of the license is successfully made. If the transfer is successfully made (Normal), the flow goes to step S289, in which the current time is encoded and recorded. Here, the process is terminated. If the transfer is unsuccessfully made, the flow goes to step S288, in which an error process is executed. Then, the flow goes to step S289, and the process is terminated.

Up to this point, the second preferred embodiment according to the present invention is described. The second preferred embodiment can be implemented by adding the function for realizing a control using the validity period of a license to the license control module of the client PC in the first preferred embodiment.

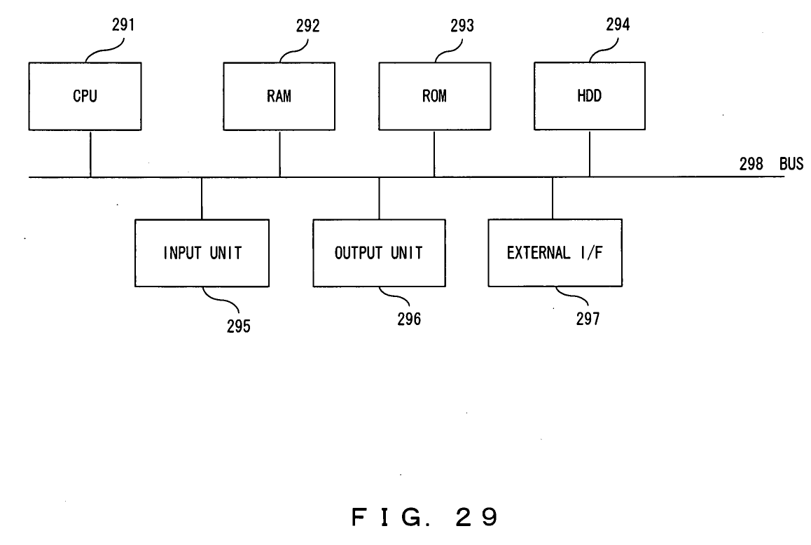

The license distribution system and the client in the first and the second preferred embodiments according to the present invention can be configured by using a computer (information processing device) shown in FIG. 29.

The computer shown in FIG. 29 comprises a CPU 291, a RAM 292, a ROM 293, an HDD 294, an input unit 295, an output unit 296, and an external interface unit 297, which are interconnected via a bus 298. These constituent elements can mutually exchange data under the control of the CPU 291.

The CPU (Central Processing Unit) 291 is a central processing unit governing the control of the operations of the entire computer, and functions as the individual license generation module 24 in the license distribution system, and the license control module 25, the decoder module 26, and the Viewer/Player 28 in the client, and the like.

The RAM (Random Access Memory) 292 is used as a working memory when the CPU 291 executes various types of processes, and also used as a main memory utilized as a temporary storage area of various types of data depending on need.

The ROM (Read Only Memory) 293 is a memory in which a basic control program executed by the CPU 291 is prestored. The CPU 291 executes the basic control program when the computer is started up, whereby the basic control of the operations of the entire computer system is performed by the CPU 291.

The HDD (Hard Disk Drive) 294 is a storage device storing a group ID list of the user management server 21, and data in the license DB 23 in the license distribution system, and distributed contents, data of the most recently recorded time, which is intended to check the current time, a program, and the like in the client.

The input unit 295 is intended to receive an external input, and to pass the contents of the input to the CPU 291. Examples of the input unit 295 include an input device operated by a user in a client, such as a keyboard, a mouse, etc. The input unit 295 is configured by further comprising a reading device of a portable storage medium such as an FD (Flexible Disk), a CD-ROM (Compact Disc-ROM), a DVD-ROM (Digital Versatile Disc-ROM), an MO (Magneto-Optics) disk, etc. depending on need.

The output unit 296 is intended to make an output according to an instruction from the CPU 291, and configured by comprising a display device such as a CRT (Cathode Ray Tube), an LCD (Liquid Crystal Display), etc., a printer device, and the like depending on need.

The external I/F (Interface) unit 297 is intended to manage a communication when data is exchanged between computers. The license distribution system and the client make a communication via the external I/F 297.

Additionally, in the preferred embodiments according to the present invention, the various types of processes shown in FIGS. 3, 8, 12, 15, 18, 24, 25, 26, 27, and 28 are executed by the CPU 291 of the computer. However, the present invention can be also implemented by storing on a computer-readable storage medium a control program for causing a computer to execute the various types of processes, and by causing the computer to read and execute the control program from the storage medium.

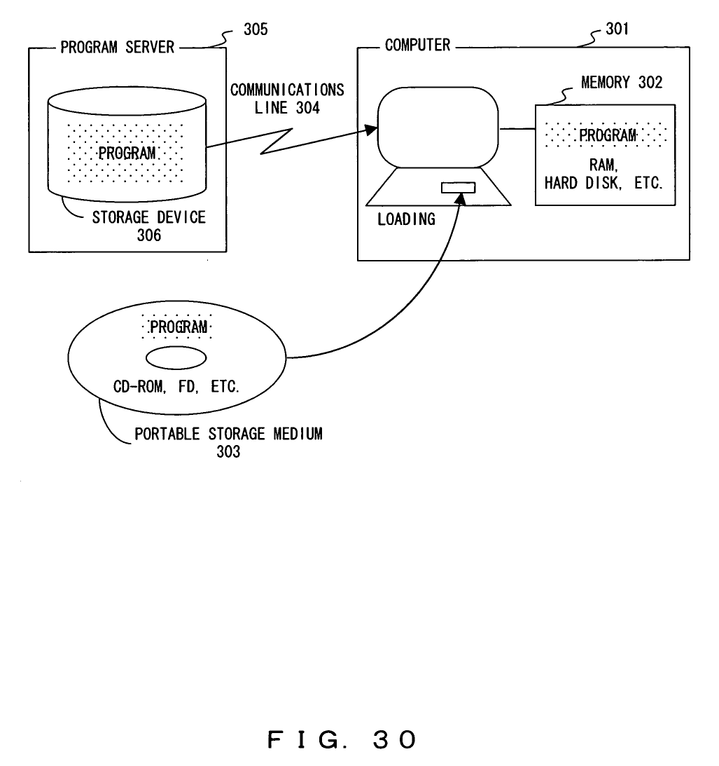

Examples of storage media from which the stored computer program can be read by a computer are shown in FIG. 30.

As shown in this figure, as the storage media, a memory 302 such as a RAM, a ROM, a hard disk, etc., which is included in or externally attached to a computer 301, a portable storage medium 303 such as a flexible disk, an MO (Magneto-Optics) disk, a CD-ROM, a DVD-ROM, etc., and the like are available.

Or, a storage device 306 comprised by a computer, which is connected to the computer 301 via a communications line 304 and functions as a program server 305, may be available as a storage medium. In this case, a transmission signal obtained by modulating a carrier wave with a data signal representing a control program is transmitted from the program server 305 over the communications line 304, which is a transmission medium, and the control program is reproduced by demodulating the received transmission signal in the computer 301, so that the control program can be executed.

Besides, the present invention is not limited to the above described preferred embodiments, and various improvements/modifications can be made within the scope which does not deviate from the gist of the present invention.

As described above in detail, according to the present invention, a group access control for confidential contents can be performed, and an effect can be increased especially for the leakage of confidential information within an organization, an enterprise, etc. Furthermore, even if a malicious user falsifies the substantial validity period of contents, a function for addressing this problem is comprised, whereby the contents can be prevented from being illegally used.

What is claimed is:

1. A method issuing a license by a computer in response to a request to access predetermined contents with a client computer, which is made by a user who belongs to at least one of a plurality of groups, comprising:
determining a group to which the user belongs based on a user ID of a user who makes a license request via the client computer, and on a group list which is stored in a storage device and associates a user ID with the group;
generating a license by referencing a permission condition of an access control list stored in the storage device storing permission conditions based on the determined group; and
outputting the generated license to the client computer.

2. The method according to claim 1, wherein
specification or non-specification of a condition of an access to the contents can be made when the license is requested by the user.

3. The method according to claim 1, wherein
if the user belongs to the plurality of groups, permission conditions which respectively correspond to the plurality of groups and are registered to the access control list are merged under a merging condition, and the license is generated based on the permission condition obtained by the merging.

4. The method according to claim 3, wherein
the merging rule is a rule which adopts a maximum permission condition among the permission conditions of the groups to which the user belongs, a rule which adopts a minimum permission condition among the permission conditions of the groups to which the user belongs, or a rule which puts the groups into an order and adopts a permission condition based on the order.

5. A program for causing a computer to execute a process for issuing a license by the computer in response to a request to access predetermined contents with a client computer, which is made by a user who belongs to at least one of a plurality of groups, the process comprising:
determining a group to which the user belongs based on a user ID of a user who makes a license request via the client computer, and on a group list which is stored in a storage device and associates a user ID with the group;
generating a license by referencing a permission condition of an access control list stored in the storage device storing permission conditions based on the determined group; and
outputting the generated license to the client computer.

6. A system, which is configured by a client computer and a server system composed of a plurality of computers, and intended to issue a license in response to a request to access predetermined contents with the client computer, which is made by a user who belongs to at least one of a plurality of groups, wherein:
the client computer comprises
client means for transmitting to the server system a user ID of a user who makes a license request; and
the server system comprises
user management means for determining a group to which the user belongs based on the user ID of the user,
license generation means for generating a license by referencing a permission condition of a registered access control list based on the determined group, and
license distribution means for distributing the generated license to said client unit.

7. A computer-readable storage medium on which is recorded a program for causing a computer to execute a process for issuing a license by the computer in response to a request to access predetermined contents with a client computer, which is made by a user who belongs to at least one of a plurality of groups, the process comprising:
determining a groups to which the user belongs based on a user ID of a user who makes a license request via the client computer, and on a group list which is stored in a storage device and associates a user ID with the group;
generating a license by referencing a permission condition of an access control list stored in the storage device storing permission conditions based on the determined group; and
outputting the generated license to the client computer.

8. A system distributing contents having a license on which a time limitation is imposed, comprising:
license distribution means for changing a validity time limit of a license to a period, and for distributing the license; and
license control means for controlling the license validity time limit of the license of the distributed contents based on the distributed license.

9. A system, which is configured by a client computer and a server system composed of a plurality of computers, and intended to issue a license in response to a request to access predetermined contents with the client computer, which is made by a user who belongs to at least one of a plurality of groups, wherein:
the client computer comprises
a client unit transmitting to the server system a user ID of a user who makes a license request; and
the server system comprises
a user management unit determining a group to which the user belongs based on the user ID of the user,
a license generation unit generating a license by referencing a permission condition of a registered access control list based on the determined group, and
a license distribution unit distributing the generated license to said client unit.

10. A system distributing contents having a license on which a time limitation is imposed, comprising:
a license distribution unit changing a validity time limit of a license to a period, and distributing the license; and
a license control unit controlling the validity time limit of the license of the distributed contents based on the distributed license.

11. The program according to claim 5, wherein
specification or non-specification of a condition of an access to the contents can be made when the license is requested by the user.

12. The program according to claim 5, wherein
if the user belongs to the plurality of groups, permission conditions which respectively correspond to the plurality of groups and are registered to the access control list are merged under a merging condition, and the license is generated based on the permission condition obtained by the merging.

13. The program according to claim 12, wherein
the merging rule is a rule which adopts a maximum permission condition among the permission conditions of the groups to which the user belongs, a rule which adopts a minimum permission condition among the permission conditions of the groups to which the user belongs, or a rule which puts the groups into an order and adopts a permission condition based on the order.
